(19) United States
(12) Patent Application Publication
(10) Pub. No.: US 2020/0254418 A1
(43) Pub. Date: Aug. 13, 2020

(54) REACTOR FOR MIXING HIGH VISCOSITY FLUIDS

(71) Applicant: LG CHEM, LTD., Daejeon (KR)

(72) Inventors: Dae Hun Kim, Daejeon (KR); Young Soo Song, Daejeon (KR); Ye Hoon Im, Daejeon (KR); Hyun Tae Jung, Daejeon (KR)

(21) Appl. No.: 16/642,661

(22) PCT Filed: Sep. 5, 2018
(86) PCT No.: PCT/KR2018/010363

§ 371 Date: Feb. 27, 2020

(30) Foreign Application Priority Data
Sep. 7, 2017 (KR) 10-2017-0114289

(51) Int. Cl. B01J 19/00; B01F 7/18; B01F 7/24; B01F 7/00; B01F 3/10; B01F 3/08

(52) U.S. Cl. CPC B01J 19/0066; B01F 7/18; B01F 7/24; B01F 3/0853; B01F 7/00291; B01F 7/0065; B01F 3/10; B01F 7/00425

(57) ABSTRACT

A reactor is described. The reactor comprises a housing having a reaction space to accommodate a reactant; an outlet pipe connected to a lower part of the reaction space; a rotating shaft disposed in the housing; and a plurality of stirring blades mounted on the rotating shaft. The housing has a lower converging region, and a cross-sectional area of the lower converging region decreases toward the outlet pipe. At least one of the plurality of stirring blades is located in the lower converging region. The outlet pipe includes a first region connected to the lower converging region and a second region extending from the first region in a discharge direction, a cross-sectional area of the first region decreases in a direction from the lower converging region toward the discharge direction, and the second region has a constant cross-sectional area.

### CROSS-REFERENCE TO RELATED APPLICATIONS

This application is the U.S. national stage of international Application No. PCT/KR2018/010363 filed on Sep. 5, 2018, and claims the benefit of priority from Korean Patent Application No. 10-2017-0114289 filed on Sep. 7, 2017, the disclosures of which are incorporated herein by reference in their entirety.

### TECHNICAL FIELD

The present invention relates to a reactor capable of improving mixing performance for a high viscosity fluid.

### BACKGROUND

In the case of the product having Bingham characteristics of filler products well used in the pharmaceutical industry, a homogenizing operation of the relevant product takes a lot of time.

FIG. 1 is a schematic diagram showing a general reactor (10).

Referring to FIG. 1, the reactor (10) comprises a housing (11), an outlet pipe (15) connected to a lower part of a reaction space of the housing (11), a rotating shaft (12) disposed in the housing and stirring blades (13, 14) mounted on the rotating shaft (12), and the homogenizing operation is performed by supplying a Bingham fluid to the housing (11) and rotating the stirring blades (13, 14).

On the other hand, in order to discharge the homogenized Bingham fluid from the reactor (10), a certain pressure is applied to the upper part of the reactor, where if the outlet area of the outlet pipe is wide, the pressure distribution on the cross section of the reactor is uneven, and thus there is a problem that only the fluid located at the center part is discharged through the outlet pipe and the fluid near the side wall of the housing is attached to the wall surface and is not discharged.

In order to prevent this, a lower region (11a) in the form, in which the radius (length in the x-axis direction) becomes narrower toward the lower end (lower part in the y-axis direction) of the reactor (10), is applied and the outlet region is narrowed to an appropriate level.

However, the shear force by the stirring blades (13, 14) is not sufficiently transferred in the lower region (11a) near the outlet pipe (15) and the Bingham fluid moves very slowly with a high viscosity, and thus there is a problem that the homogenization of the product must be performed very long.

### SUMMARY

A problem to be solved by the present invention is to provide a reactor capable of improving mixing performance when mixing a high viscosity fluid.

To solve the above-described problem, according to one aspect of the present invention, there is provided a reactor comprising a housing having a reaction space in which a reactant is accommodated, an outlet pipe connected to a lower part of the reaction space, a rotating shaft disposed in the housing and stirring blades mounted on the rotating shaft, wherein the housing has a lower converging region with a smaller cross-sectional area toward the outlet pipe side, at least a part of the stirring blades is located in the lower converging region and the outlet pipe comprises a first region having a reduced cross-sectional area along the discharge direction of the reactant and connected to the lower converging region, and a second region extending along the discharge direction from the first region and having a constant cross-sectional area.

As described above, the reactor related to one example of the present invention has the following effects.

The shear force by the impeller can be sufficiently transferred to the lower discharge region of the reactor, and thus the homogenization of the reactant can be performed quickly.

Also, when stirring a high viscosity fluid such as a Bingham fluid, the high viscosity region at the lower end of the reactor can be reduced and the mixing performance can be improved.

### BRIEF DESCRIPTION OF DRAWINGS

FIG. 1 is a schematic illustration of a general reactor.

FIG. 2 is a schematic illustration of a reactor according to an exemplary embodiment.

FIG. 3 shows the analysis result of the viscosity distribution in the reactor of FIG. 1.

FIG. 4 shows the analysis result of the viscosity distribution in the reactor of FIG. 2.

FIG. 5 is a graph comparing the mixing performance of the reactors according to FIGS. 1 and 3.

### DETAILED DESCRIPTION

Hereinafter, a reactor according to one example of the present invention will be described in detail with reference to the accompanying drawings.

In addition, the same or similar reference numerals are given to the same or corresponding components regardless of reference numerals, of which redundant explanations will be omitted, and for convenience of explanation, the size and shape of each constituent member as shown may be exaggerated or reduced.

FIG. 2 is a schematic illustration of a reactor (100) according to one embodiment of the present invention.

The reactor (100) comprises a housing (110) having a reaction space in which a reactant is accommodated and an outlet pipe (140) connected to a lower part of the reaction space. The reactor (100) also comprises a rotating shaft (120) disposed in the housing (110) in the height direction (y-axis direction) and stirring blades (131, 132) mounted on the rotating shaft (120). In addition, the reactor (100) comprises a driving part (not shown) for rotating the rotating shaft (120).

Furthermore, the reactant may be a Bingham fluid, which is a high viscosity fluid.

In addition, the housing (110) has a lower converging region (111) in which the cross-sectional area (or the radius (length in the x-axis direction)) decreases toward the outlet pipe (140) side.

Also, at least a part (e.g., 132) of the stirring blades (131, 132) is located in the lower converging region (111). The stirring blades are installed along the height direction of the rotating shaft, and for example, two or more kinds of stirring blades may be installed in predetermined regions in order along the height direction of the rotating shaft. In addition, the stirring blades may comprise a spiral blade (131) and a paddle-shaped blade (132). At this time, the paddle-shaped blade (132) may be located in the lower converging region (111).

The outlet pipe (140) comprises a first region (141) having a reduced cross-sectional area along the discharge direction of the reactant and connected to the lower converging region (111), and a second region (142) extending along the discharge direction from the first region (141) and having a constant cross-sectional area. The outlet pipe (140) may have a roughly funnel shape. For homogenization improvement and easy discharge of the Bingham fluid, the outlet pipe can be designed to have a wide outlet diameter (first region).

In addition, the maximum diameter of the first region (141) in the outlet pipe (140) may be the same as the minimum diameter of the lower converging region (111). At this time, the inner peripheral surface of the lower converging region (111) in the housing and the inner peripheral surface of the first region (141) in the outlet pipe (140) can form the same surface without a step. In addition, the length of the lower converging region (111) may be greater than the length of the first region (141) based on the discharge direction (the y-axis direction or the height direction of the rotation axis).

Furthermore, the minimum diameter of the first region (141) in the outlet pipe (130) may be the same as the diameter of the second region (142).

Also, the reactor (100) may comprise a pressurizing part (not shown) for applying pressure to an upper region of the reaction space when the reactant is discharged.

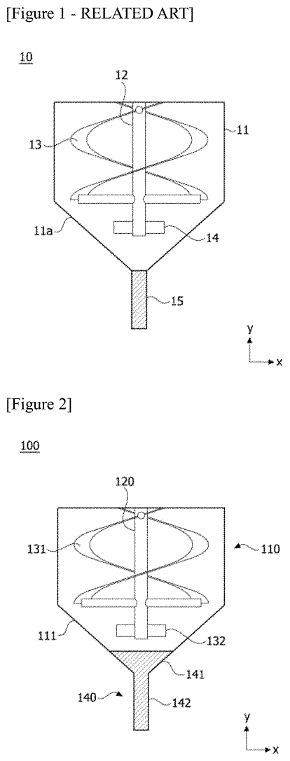

Referring to FIG. 2, it can be confirmed that the gap between the first region and the stirring blade (132) is reduced by the outlet pipe (140) and the volume of the lower converging region (111) is reduced as compared to the reactor of FIG. 1.

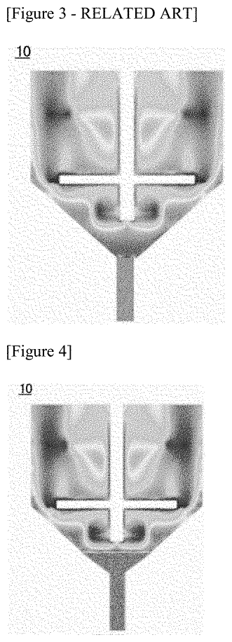

FIG. 3 shows the analysis result showing the viscosity distribution in the reactor (10) of FIG. 1, and FIG. 4 shows the analysis result showing the viscosity distributions in the reactor (100) of FIG. 2.

Referring to FIG. 4, the lower mixing performance increases because the shear force is transferred more uniformly when the stirring blade rotates.

Furthermore, for easy discharge of the fluid, the outlet pipe (140) is configured in the form in which the radius becomes narrower toward the lower part, so that even when the pressure is applied at the upper part of the reactor during discharge, the pressure distribution on the cross section of the reactor can be formed evenly, and thus the production amount can be maintained.

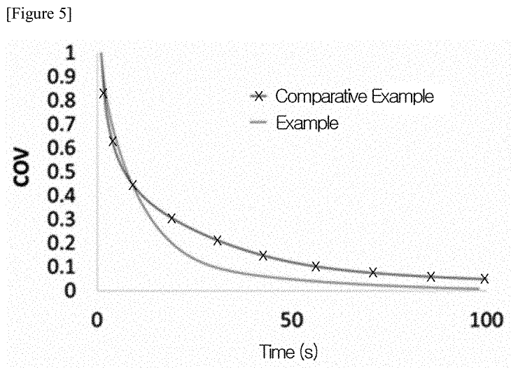

In addition, FIG. 5 is a graph for comparing mixing performance of the reactors according to FIG. 1 (Comparative Example) and FIG. 3 (Example).

In order to confirm the mixing performance of the lower region in the reactor, a CoV (coefficient of variation) has been used as a mixing index, where it can be determined that the closer the CoV is to zero, the better the mixing performance.

As shown in FIG. 3, the decrease in CoV over time is accelerated, whereby it can be confirmed that the mixing performance is improved.

The preferred examples of the present invention as described above are disclosed for illustrative purposes, which can be modified, changed and added within thought and scope of the present invention by those skilled in the art and it will be considered that such modification, change and addition fall within the following claims.

According to the reactor related to one example of the present invention, when the high viscosity fluid such as the Bingham fluid is stirred, the high viscosity region at the lower end of the reactor can be reduced and the mixing performance can be improved.

1. A reactor comprising:
a housing having a reaction space to accommodate a reactant;
an outlet pipe connected to a lower part of the reaction space;
a rotating shaft disposed in the housing; and
a plurality of stirring blades mounted on the rotating shaft,
wherein the housing has a lower converging region, wherein a cross-sectional area of the lower converging region decreases toward the outlet pipe,
wherein at least one of the plurality of stirring blades is located in the lower converging region and
wherein the outlet pipe comprises a first region connected to the lower converging region and a second region extending from the first region in a discharge direction, wherein a cross-sectional area of the first region decreases in a direction from the lower converging region toward the discharge direction, and wherein the second region has a constant cross-sectional area.

2. The reactor according to claim 1,
wherein a maximum diameter of the first region in the outlet pipe is the same as a minimum diameter of the lower converging region.

3. The reactor according to claim 1,
wherein a minimum diameter of the first region is the same as a diameter of the second region.

4. The reactor according to claim 1,
wherein the plurality of stirring blades comprises a spiral blade and a paddle-shaped blade.

5. The reactor according to claim 4,
wherein the paddle-shaped blade is located in the lower converging region.

6. The reactor according to claim 1,
wherein the reactant is a Bingham fluid.

7. The reactor according to claim 1,
further comprising a pressurizing part for applying pressure to an upper region of the reaction space when the reactant is discharged.

8. The reactor according to claim 1, wherein an inner peripheral surface of the first region and the outlet pipe forms a continuous surface without an intervening step.
